(19) United States
(12) Patent Application Publication
(10) Pub. No.: US 2015/0254366 A1
(43) Pub. Date: Sep. 10, 2015

(54) APPLICATION SOFTWARE, ELECTRONIC FORMS, AND ASSOCIATED METHODS

(71) Applicants: Michael A. Ravagnani, Westerville, OH (US); Kevin D. Rall, Crestline, OH (US)

(72) Inventors: Michael A. Ravagnani, Westerville, OH (US); Kevin D. Rall, Crestline, OH (US)

(73) Assignee: REVOLUTION GROUP, INC., Westerville, OH (US)

(21) Appl. No.: 14/642,154

(22) Filed: Mar. 9, 2015

Related U.S. Application Data
(60) Provisional application No. 61/949,494, filed on Mar. 7, 2014.

(51) Int. Cl. G06F 17/30; G06F 17/27; H04L 12/58

(52) U.S. Cl. CPC G06F 17/30896; H04L 51/02; G06F 17/2705

(57) ABSTRACT

A system for facilitating automatic population of a database, including a carrier component storing information in a carrier format to be submitted to a user. A retrieval component accesses and retrieves information on the carrier component. A translating component converts the retrieved information from the carrier format into the database compatible format. A database component stores the retrieved information in a database compatible format. A method for facilitating mapping of a form, including: selecting a first object field from the database object; selecting a first form field from the selected form; and mapping the first object field to the first form field is also provided.

### CROSS REFERENCE TO RELATED APPLICATIONS

This application claims the benefit of U.S. Provisional Patent application Ser. No. 61/949,494 entitled “APPLICATION SOFTWARE, ELECTRONIC FORMS, AND ASSOCIATED METHODS FOR USE BY INSURANCE AGENCIES” and filed Mar. 7, 2014. The entirety of the above-noted application is incorporated by reference herein.

### BACKGROUND

Insurance agencies interact with insurance carriers to receive information regarding insurance policies and other data regarding customers. Conventionally, the information is shared between the agent and the carrier where the agent manually sorts, organizes, and retrieves the information provided by the carrier. Further, the information is used in various forms. The forms typically include fields for specific types of data or information about the policies such as name, account number, type of policy, and the like. Populating such forms manually is considerably time consuming for insurance agencies and creates large amounts of overhead. There is a need for an automated process for retrieving the information and populating an insurance agency database and subsequent forms.

### SUMMARY

The following presents a simplified summary of the subject innovation in order to provide a basic understanding of some aspects of the subject innovation. This summary is not an extensive overview of the subject innovation. It is not intended to identify key/critical elements of the subject innovation or to delineate the scope of the subject innovation. Its sole purpose is to present some concepts of the subject innovation in a simplified form as a prelude to the more detailed description that is presented later.

The subject innovation disclosed and claimed herein, in aspects thereof, comprises systems and methods that can translate information retrieved from an insurance carrier and automatically populate fields in an insurance database based on the translated information.

In other embodiments, the subject innovation can include systems and methods related to mapping data to one or more forms, as well as systems and methods of creating one or more electronic forms as described herein, in accordance with aspects of the subject innovation.

To the accomplishment of the foregoing and related ends, certain illustrative aspects of the subject innovation are described herein in connection with the following description and the annexed drawings. These aspects are indicative, however, of but a few of the various ways in which the principles of the subject innovation can be employed and the subject innovation is intended to include all such aspects and their equivalents. Other advantages and novel features of the subject innovation will become apparent from the following detailed description of the subject innovation when considered in conjunction with the drawings.

### BRIEF DESCRIPTION OF THE DRAWINGS

FIG. 1 illustrates a system for retrieving, translating, and populating information into a database or form.

FIG. 2 illustrates screenshots associated with an embodiment related to retrieval of information into a database in accordance with aspects of the subject innovation.

FIG. 3 illustrates additional screenshots associated with an embodiment related to retrieval of information into a database in accordance with aspects of the subject innovation.

FIG. 4 illustrates further screenshots associated with an embodiment related to translation and automatic population of information into a database in accordance with aspects of the subject innovation.

FIG. 5 illustrates a method of mapping data to one or more forms, as well as a method of creating one or more electronic forms as described herein, in accordance with aspects of the subject innovation.

FIG. 6 illustrates screenshots associated with an embodiment of the subject innovation related to mapping data to forms.

FIG. 7 illustrates additional screenshots associated with an embodiment of the subject innovation related to mapping data to forms.

FIG. 8 illustrates further screenshots associated with an embodiment of the subject innovation related to mapping data to forms.

FIG. 9 illustrates an example form created in accordance with an embodiment of the subject innovation.

FIG. 10 illustrates screenshots associated with an embodiment of the subject innovation related to creating one or more electronic forms as described herein.

FIG. 11 illustrates additional screenshots associated with an embodiment of the subject innovation related to creating one or more electronic forms as described herein.

FIG. 12 illustrates further screenshots associated with an embodiment of the subject innovation related to creating one or more electronic forms as described herein.

FIG. 13 illustrates further screenshots associated with an embodiment of the subject innovation related to creating one or more electronic forms as described herein.

FIG. 14 illustrates a computer-readable medium or computer-readable device comprising processor-executable instructions configured to embody one or more of the provisions set forth herein, according to some embodiments.

FIG. 15 illustrates a computing environment where one or more of the provisions set forth herein can be implemented, according to some embodiments.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the subject innovation can be practiced without these specific details. In other instances, well-known structures and devices are shown in block diagram form in order to facilitate describing the subject innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

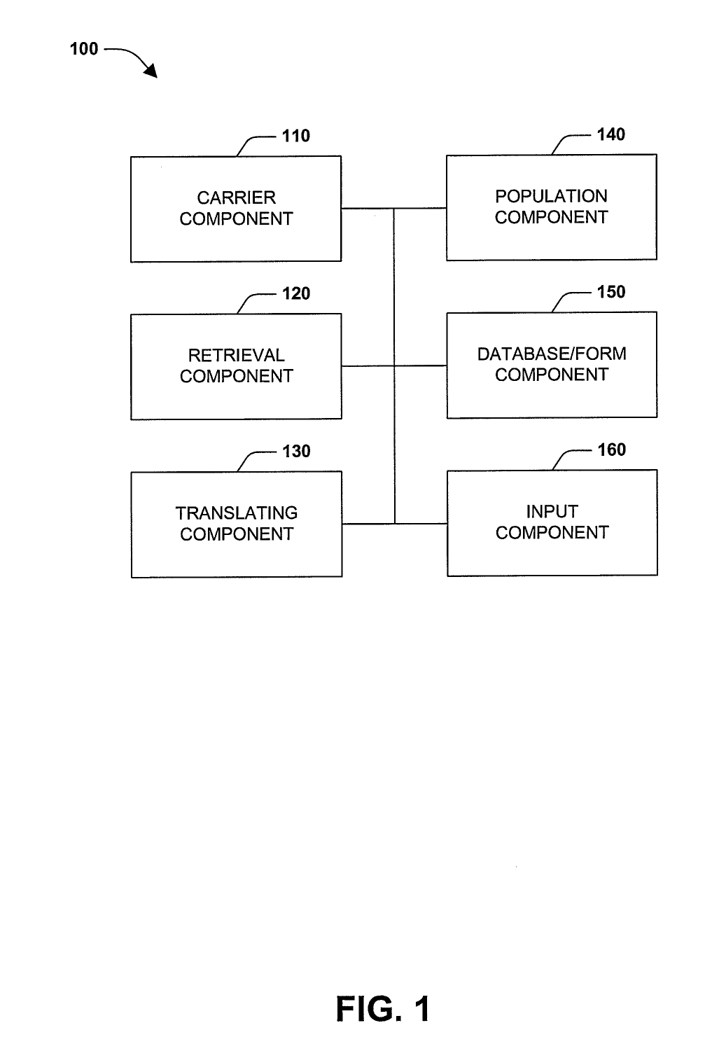

With reference to FIG. 1, a system 100 for retrieving, translating, and populating forms is depicted. The system 100 includes a carrier component 110, a retrieval component 120, a translating component 130, a population component 140, a database component 150, and an input component 160. The system 100 includes one or more processors that provides a web application that can facilitate management of an insurance agency (or a related type of entity). In various aspects, such a system can include a database component 150, such as one built on the Salesforce.com database or another customer relationship management solution database, and can include a package with one or more objects that can modify the existing database to be focused more specifically on customer relationship management (CRM) solutions related to the insurance industry. Such modifications can include one or more fields specific to the insurance industry, such as fields for account, policy or policies, coverage, etc.

The system 100 accesses the carrier component 110, which includes insurance policies and other information relating to an insurance carrier. The carrier component 110 can be a database this is remotely located at an insurance carrier and accessed via a network. The retrieval component 120 can retrieve information directly from one or more insurance carriers of the carrier component 110. The retrieval component 120 receives the information for insurance policies and other associated information that a user (e.g., insurance agent, insurance agency, etc.) manages and is associated with each of the one or more insurance carriers. For most insurance carriers, the information is stored by the insurance carrier according to a set of standards (e.g. AL3 standards) maintained by the Association for Cooperative Operations Research and Development (ACORD). In such a case, the translating component 130 converts retrieved information from an information standard such as the AL3 standards into an information format associated with the database (e.g., a customer relationship management solution format). The converted information can then be uploaded into the database component 150. The database component 150 can include entries having fields that can be automatically populated based on information maintained by the insurance carriers (e.g., in the AL3 standard). The population component 140 inserts the entries into the database component 150 and automatically populates fields in the database component 150 based at least in part on the retrieved information.

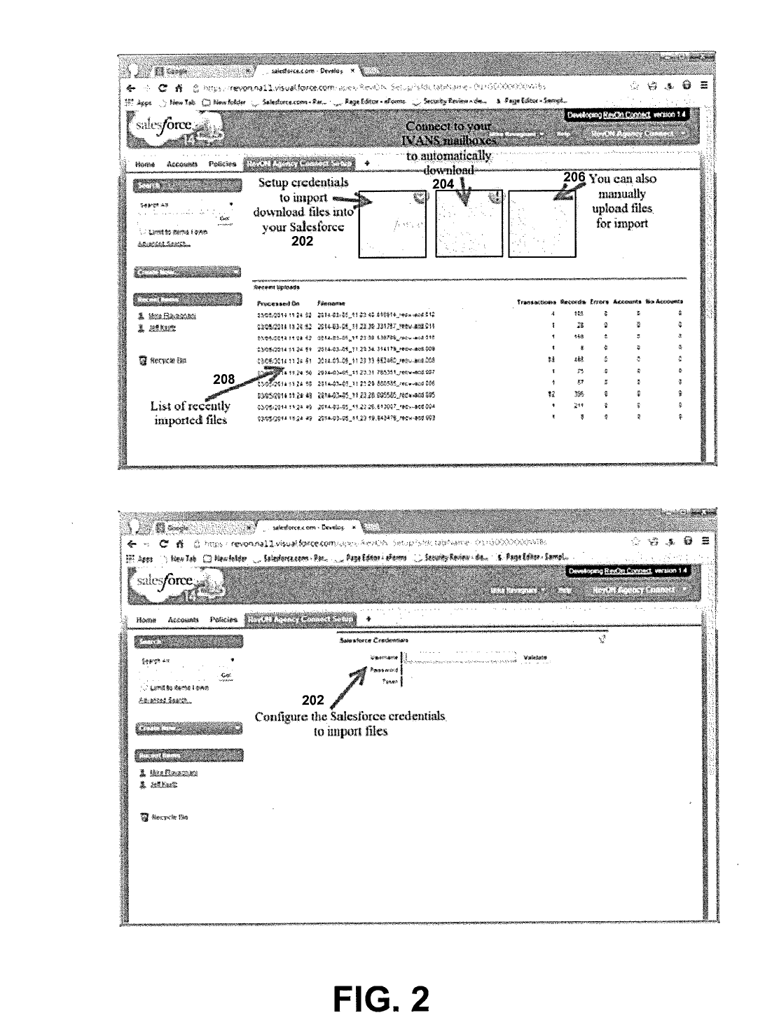

With reference also to FIGS. 2-4, screenshots are illustrated associated with an embodiment related to retrieval of information into a database in accordance with aspects of the subject innovation. The system includes a user login 202 function in which the user inputs credentials to gain access to the carrier component 110 and the information stored by the insurance carrier. The credentials can include a username, password, token, or other credentials.

FIG. 2 depicts selectable retrieval options that are available and presented to the user, including mailbox retrieval 204, manual upload 206, and the like. Data can be obtained from insurance carriers in a variety of ways, which can depend on the practices of the insurance carrier. For example, several insurance carriers will provide data in an AL3 format to agencies via a mailbox, wherein an agency receives information from an insurance carrier in the mailbox and retrieves that information to add to their database. In such embodiments, an agency can additionally provide the carrier contact information associated with the system, wherein the retrieval component 120 can receive a copy of information provided to the agency, and use this copy for translation and population of fields. In general, in situations in which a carrier automatically provides information to an agency, this information or a copy of it can be automatically retrieved by the retrieval component 120 for subsequent translation, etc. In some situations, however, carriers require agencies to manually retrieve information from the carrier, and in such situations, the manually retrieved information can be provided to an embodiment of the subject innovation by the agency.

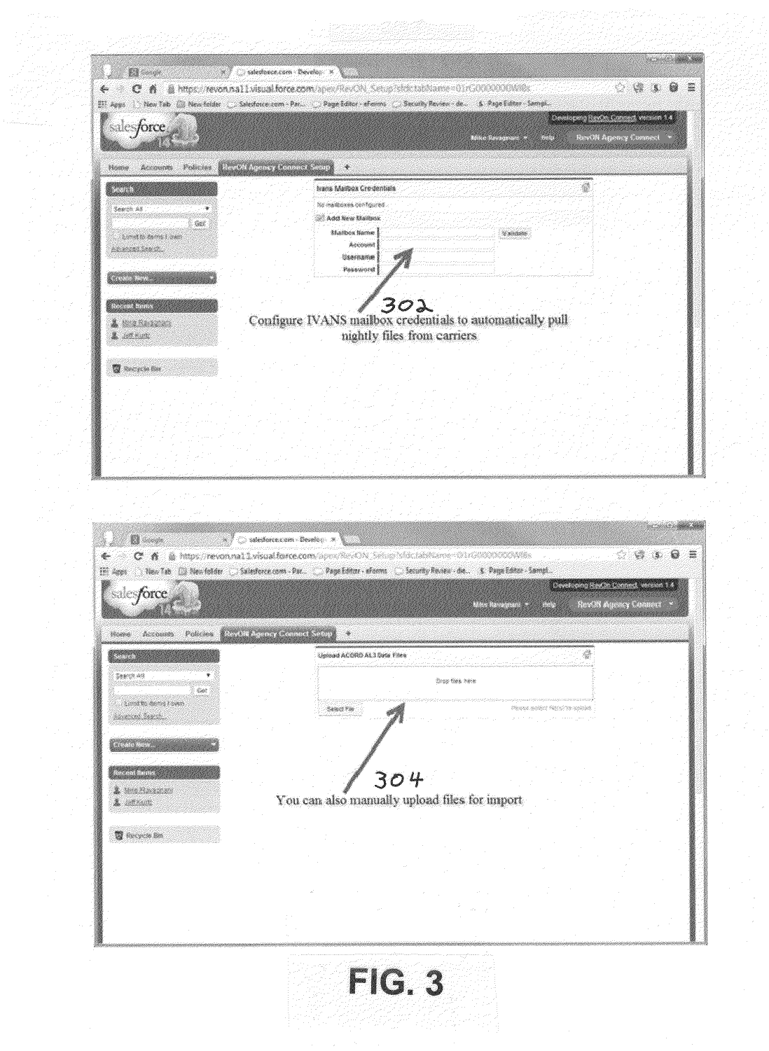

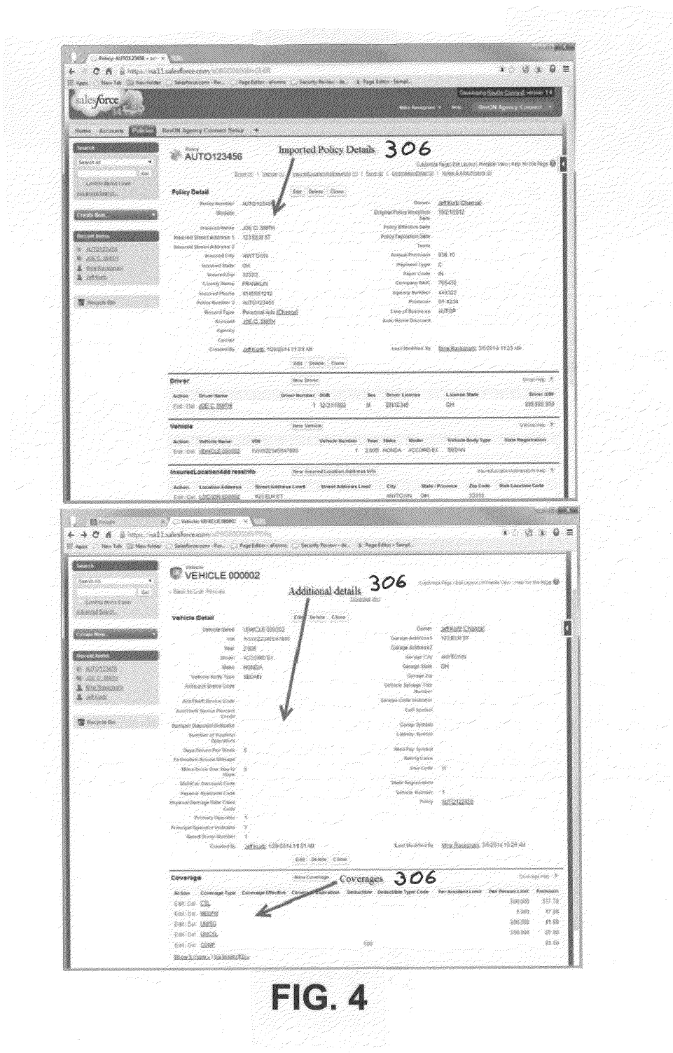

With reference to FIG. 3, as an example of the mailbox scenario described above, in many situations, insurance carriers use a commercial lines download service such as IVANS to communicate with insurance agencies. For example, for policies with which an insurance agency is associated, an insurance carrier using the commercial lines download service will put associated data in a mailbox on the commercial lines download service system. The user can configure the commercial lines download service mailbox by inputting credentials 302 such as mailbox name, account information, username, and/or password. Conventionally, a user, e.g. an agency, would download information from the commercial lines download service, and then enter the information into the agency's database. The retrieval component 120 can automatically retrieve such information from the commercial lines download service system for a given user (e.g., insurance agency), downloading that information, and the translating component 130 converts that information from a format in which it is initially presented or maintained (e.g., AL3, etc.) into a format native to the database component 150 (e.g., the customer relationship management solution format, etc.). With reference to FIG. 4, the population component 140 populates the fields 306 for each entry in the database component 150 with the converted information.

The user interacts with the various components via an input component 160. The input component 160 may be implemented as software or hardware, as buttons, keys, a keyboard, including a microphone, or can be received from the user device.

In some embodiments, information can be presented in a form tailored for individual agencies, while in other embodiments information can be presented in a form customized for an insurance aggregator, such as in an aggregated format, e.g., showing summarized policy information by agency, by product line, etc.

In various embodiments, the system 100 can also include a web portal whereby a user can access information associated with the automation processes. Such a portal or page can provide information showing carriers (to which the system has access in connection with the user's data) information regarding data flow management, and provide the user the ability to manage associated options, provide access for automated information retrieval and database population, etc.

Much in the same way a database component 150 is populated, the system 100 can generate or populate forms. Typically, the way an agency provides insurance quotes is to collect policy data, and assemble that data into a portable document format (PDF) document, for example an ACORD form. This PDF (e.g., ACORD) form can be used in the same way in which a manually created form is used. The uses can depend on the nature of the form, and can include providing the form directly to a carrier (e.g., via mail, electronically, etc.) for rating, and/or using the form in another software application (e.g., pulling form data into another application (e.g., a comparative rater and/or agency management system such as EZLynx or another workflow management application) from the PDF document, in order to take the information to one or more comparative raters to provide multiple quotes), and etc.

The system 100 can automate, at least in part, generation and population of forms useable in the same manner as conventional forms. In aspects, data provided in a database associated with an insurance agency, e.g. carrier component 110, can be mapped by an agency database component 150 (e.g., customer relationship management solution database, etc.) into a field in an electronic form of the system 100. The electronic form can then be used in a variety of ways, e.g., to provide information to a comparative rater, either directly or through an application such as an agency management system.

In various embodiments, users of the system can map substantially any field in a user database component 150 (e.g., associated with an insurance agency) with any field associated with an electronic form via the input component 160, which facilitates PDF generation while allowing users to maintain customized databases that fit their individual needs and/or preferences. The translating component 130 converts information that is in a format associated with the database component (e.g., a customer relationship management solution format) into a format useable for comparative rating (e.g., an ACORD format). By allowing the mapping of fields, information can be provided in an automated manner which is both faster and less error-prone than manual entry of fields in the form.

In aspects, the system 100 generates any of a variety of standardized forms (e.g., ACORD forms), and allows for the mapping and automatic field population of those forms as described herein.

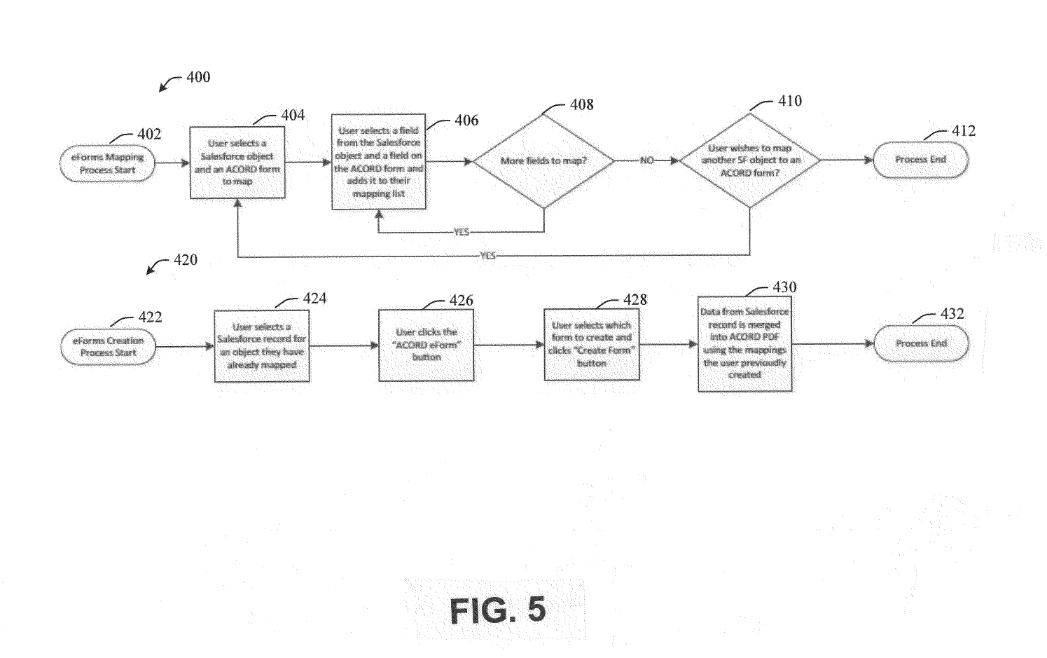

FIG. 5 illustrates a method 400 of mapping data to one or more forms, as well as a method 420 of creating one or more electronic forms as described herein, in accordance with aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the subject innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject innovation.

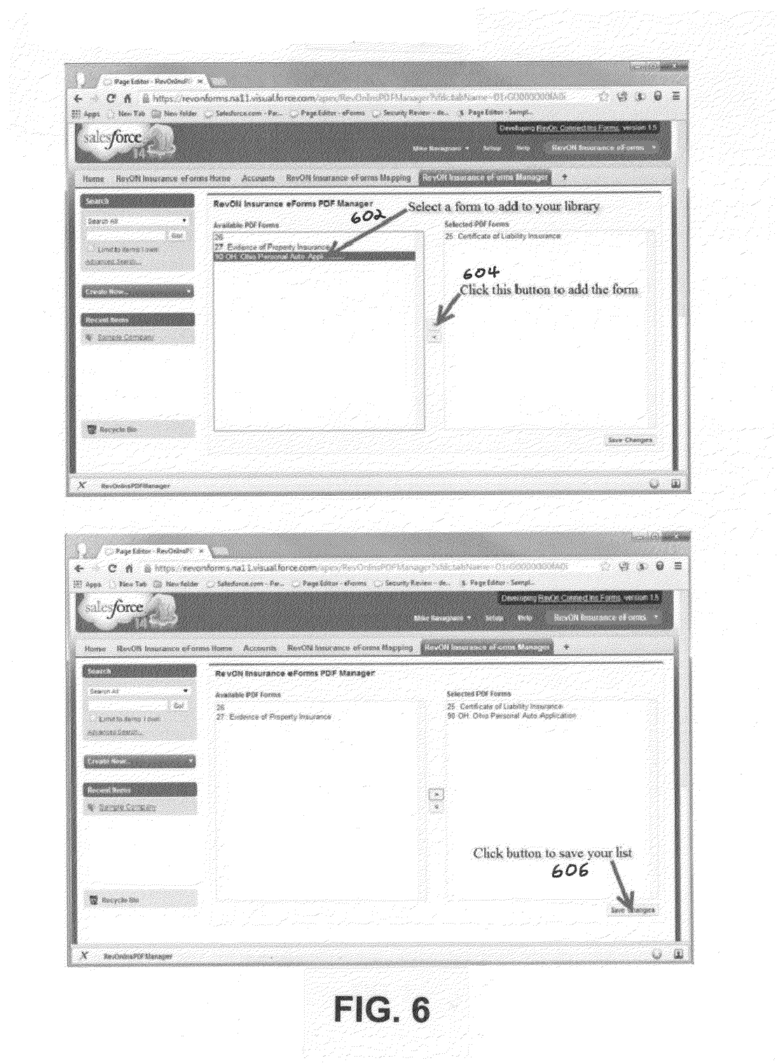

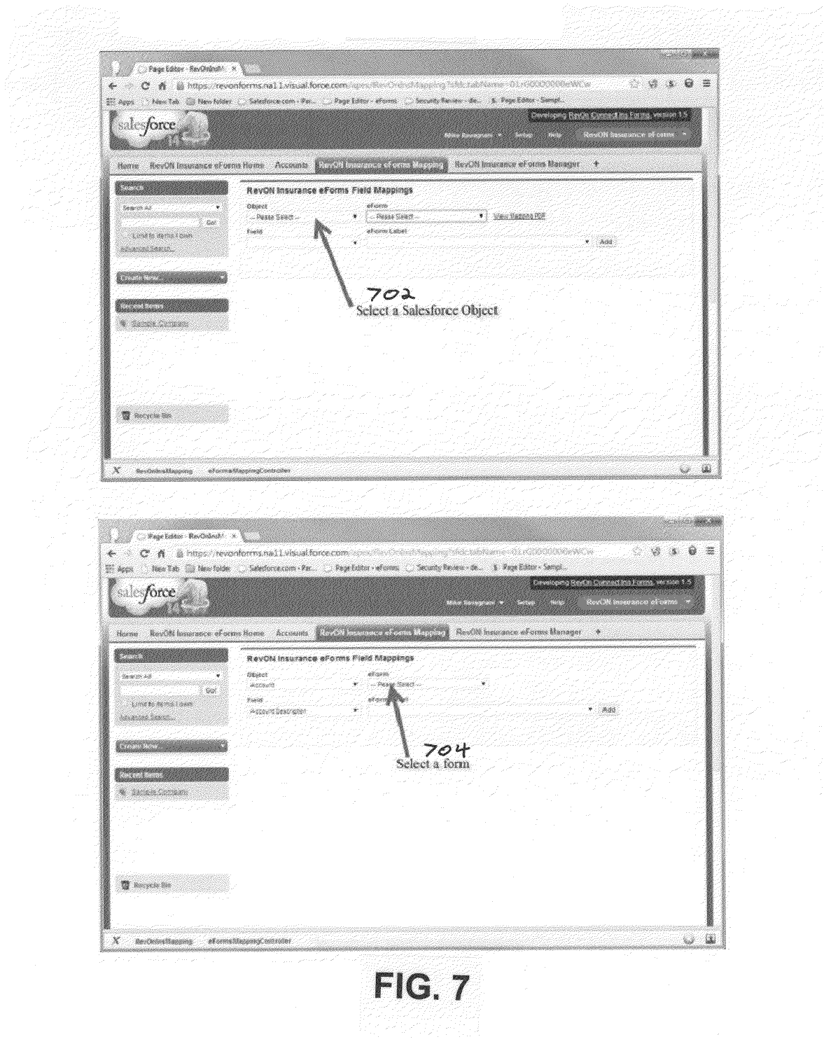

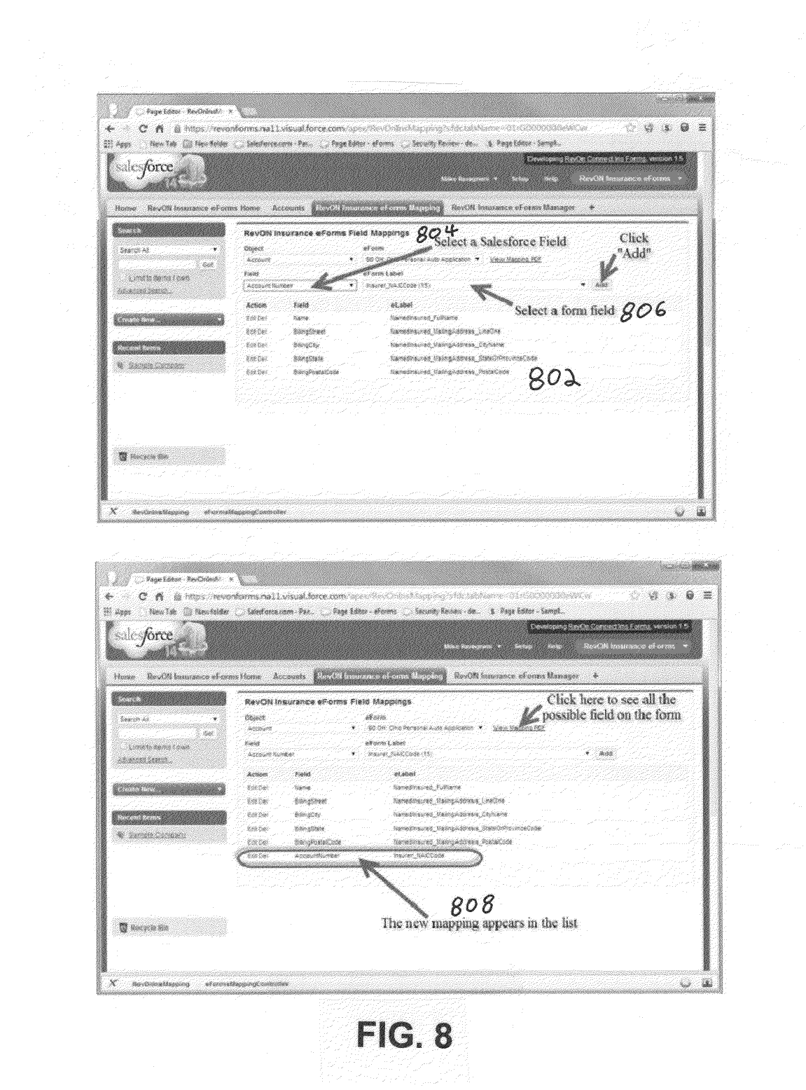

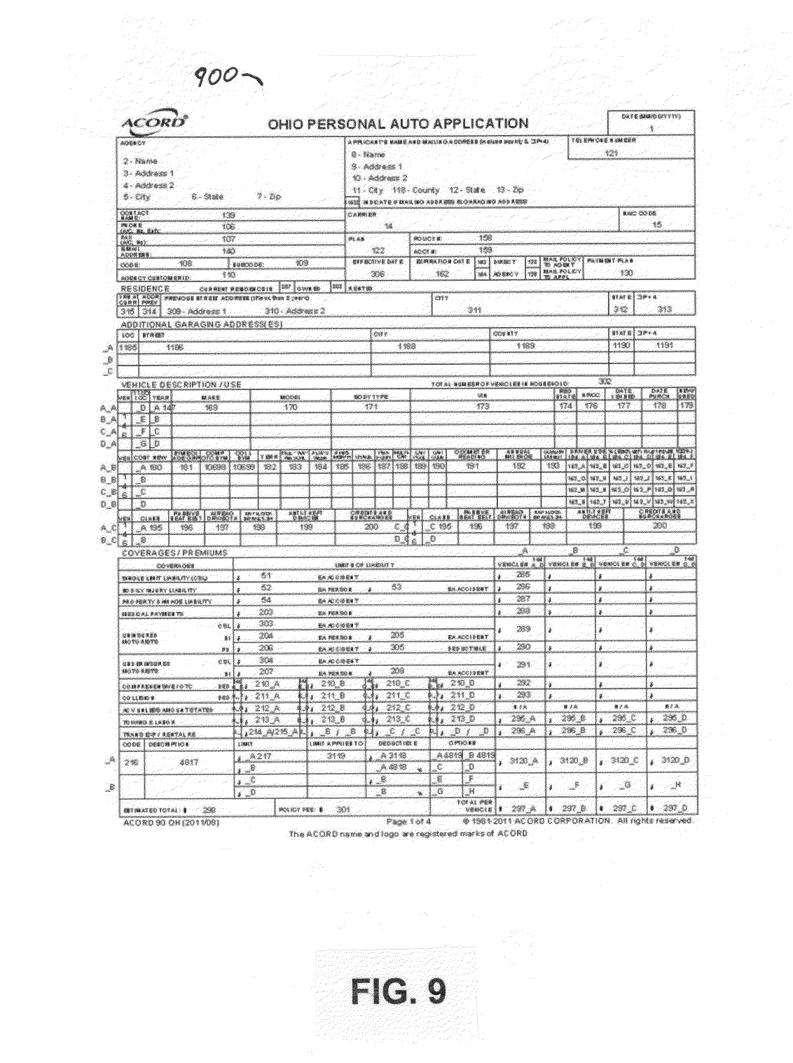

With reference also to FIGS. 6-8, screenshots illustrate an embodiment of the method 400 related to mapping data to forms. Method 400 can begin at 402, and at act 404, a user can select a database (e.g., customer relationship management solution) object 602 listing available forms and add a form 604 (e.g., ACORD form) to map information from the object into the form. Multiple forms can be selected and saved 606 for mapping. At 406, the user can select a first object field 702 from the object and a first form field 704 from the form, and add that pair of fields to a mapping list 802, wherein the data in the first object field will be mapped into the first form field. At 408, a determination can be made (e.g., via user selection, etc.) whether additional fields are to be mapped in populating the form. If additional fields are to be mapped, method 400 can return to 406, where a user can select a next (e.g., second, third, etc.) object field 804 from the object and a next form field 806 from the form, and add that pair of fields to an updated mapping list 808. The process can proceed between acts 406 and 408 until all fields are mapped. Once no more fields are to be mapped, method 400 can proceed to 410 and a determination can be made whether information from the same or another object is to be mapped into a second form. If so, method 400 can return to 404 for mapping of the second form. If not, method 400 can end at 412. With reference to FIG. 9, an exemplary form 900 created in accordance with system and method described above is illustrated.

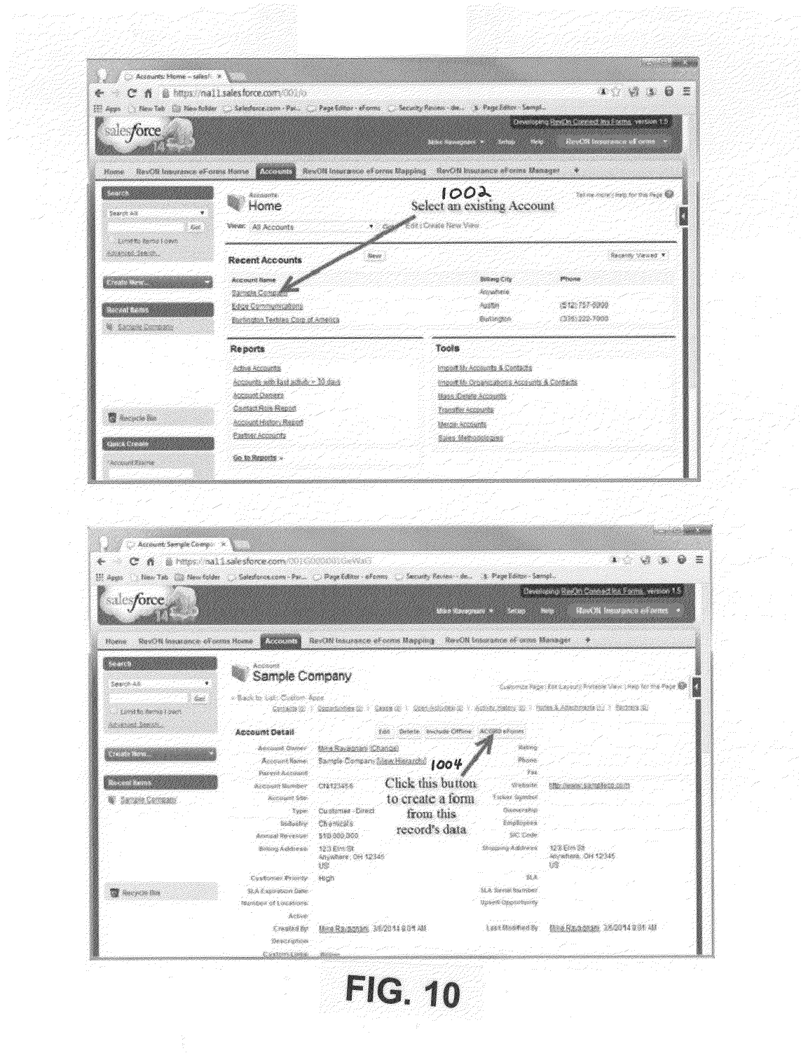

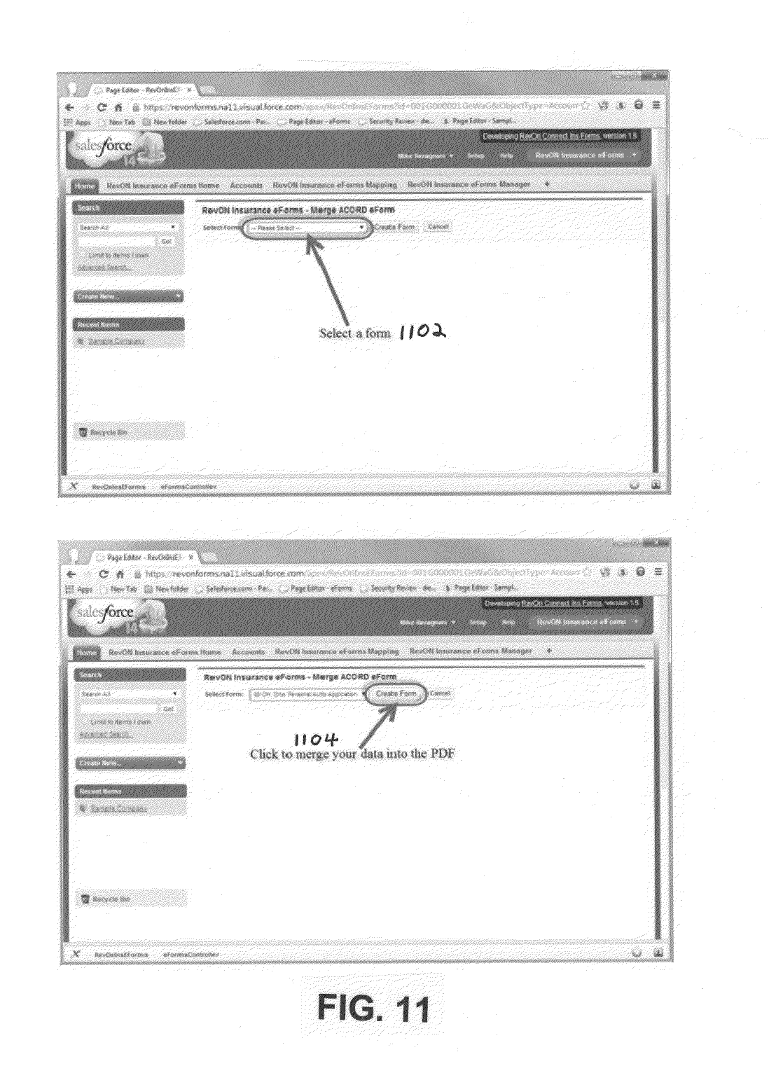

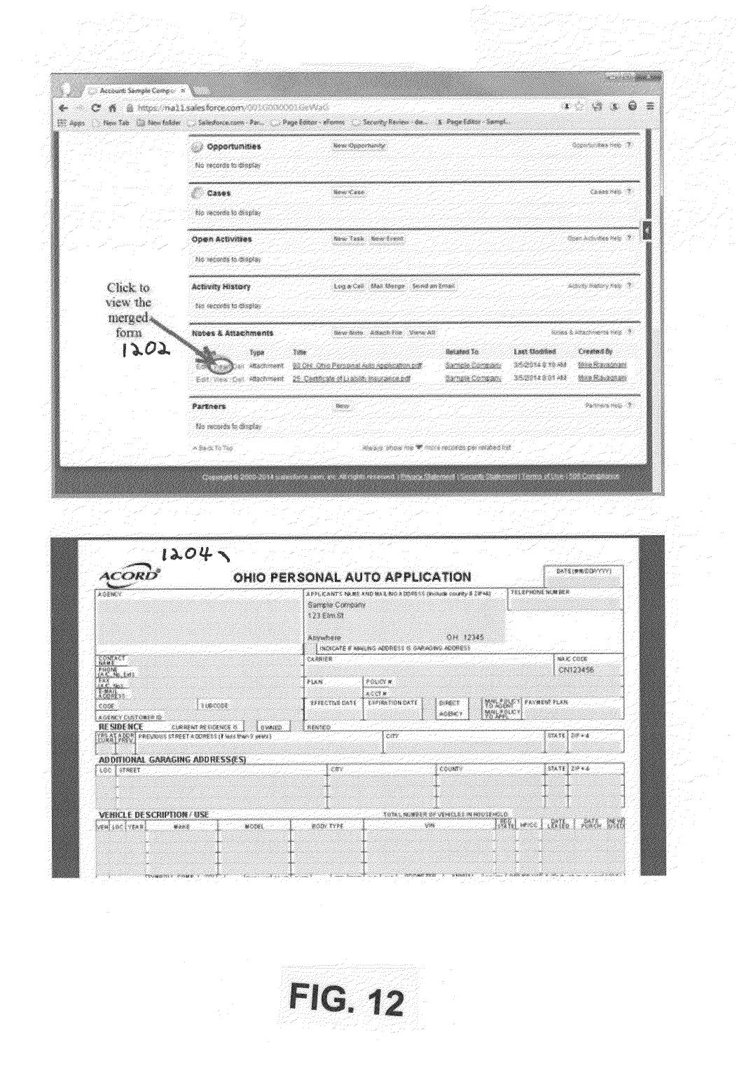

With reference to also FIGS. 10-12, screenshots illustrate an embodiment of the method 420 related to mapping data to forms. Method 420 can begin at 422, and at 424, a user can select a record (e.g., customer relationship management solution record, etc.) for an object that has been previously mapped (e.g., according to method 400, etc.) from a selected existing account 1002. At 426, the user can select to generate 1004 one or more forms based at least in part on the previously mapped object. In one embodiment, the type of generated forms can be one of an ACORD eform, an ACORD eform PDF format, an Acord eform XML format, and the like. At 428, the user can designate one or more forms to create 1102, and the one or more forms can be created based on the designation. At 430, data from the record can be merged 1104 into a form (e.g., ACORD PDF) based at least in part on the previously mapped object (e.g., based on a mapping list, etc.). After the merging, the method can end at 432. The user can optionally select to review 1202 the merged form at 1204.

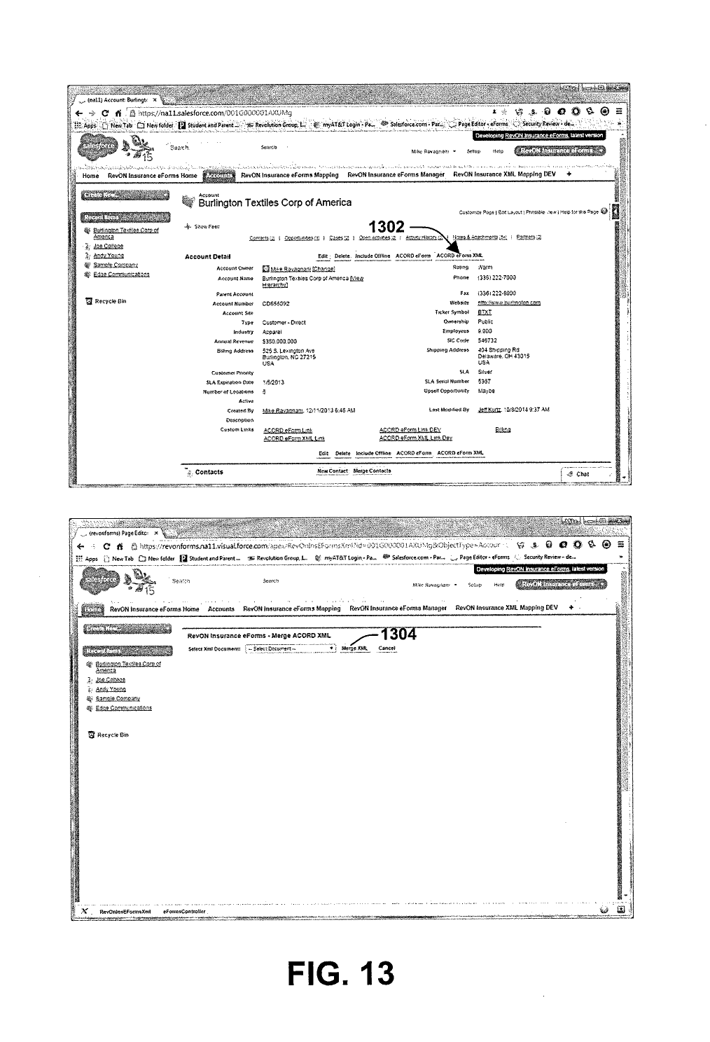

With reference to FIG. 13, in an alternate embodiment of the method 420, mentioned above, the user can select, at 426, to generate 1302 a form in an XML format file. Further, the user can alternatively select, at 430, to merge the data from the record into an XML format file, e.g. an ACORD eform XML file.

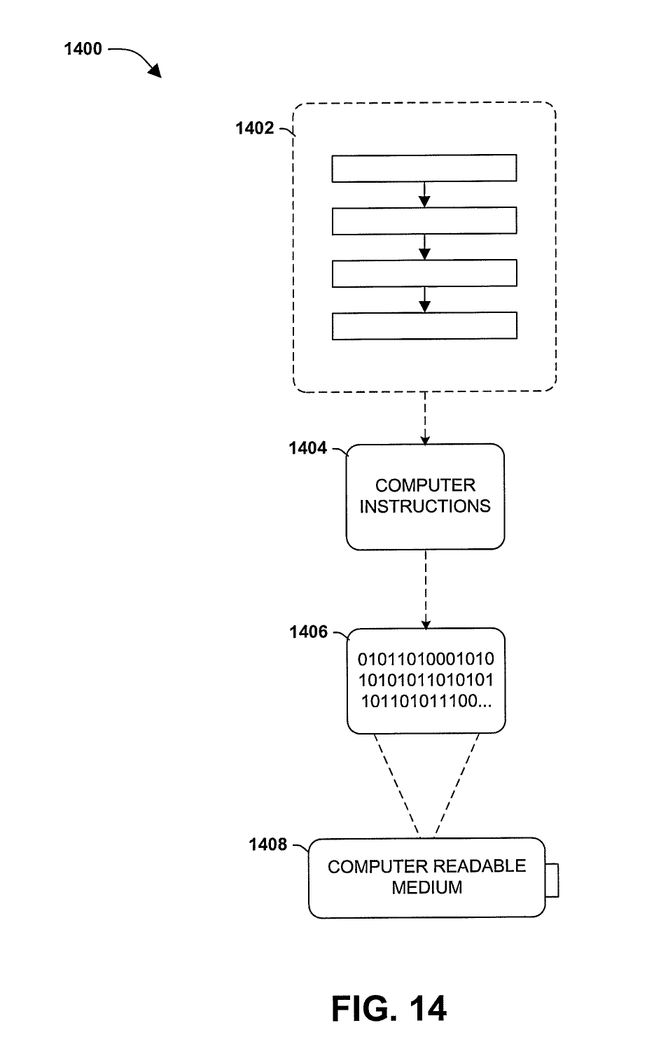

Still another embodiment can include a computer-readable medium comprising processor-executable instructions configured to implement one or more embodiments of the techniques presented herein. An embodiment of a computer-readable medium or a computer-readable device that is devised in these ways is illustrated in FIG. 14, wherein an implementation 1400 comprises a computer-readable medium 1408, such as a CD-R, DVD-R, flash drive, a platter of a hard disk drive, etc., on which is encoded computer-readable data 1406. This computer-readable data 1406, such as binary data comprising a plurality of zero's and one's as shown in 1406, in turn comprises a set of computer instructions 1404 configured to operate according to one or more of the principles set forth herein. In one such embodiment 1400, the processor-executable computer instructions 1404 is configured to perform a method 1402, such as at least a portion of one or more of the methods described in connection with embodiments disclosed herein. In another embodiment, the processor-executable instructions 1404 are configured to implement a system, such as at least a portion of one or more of the systems described in connection with embodiments disclosed herein. Many such computer-readable media can be devised by those of ordinary skill in the art that are configured to operate in accordance with the techniques presented herein.

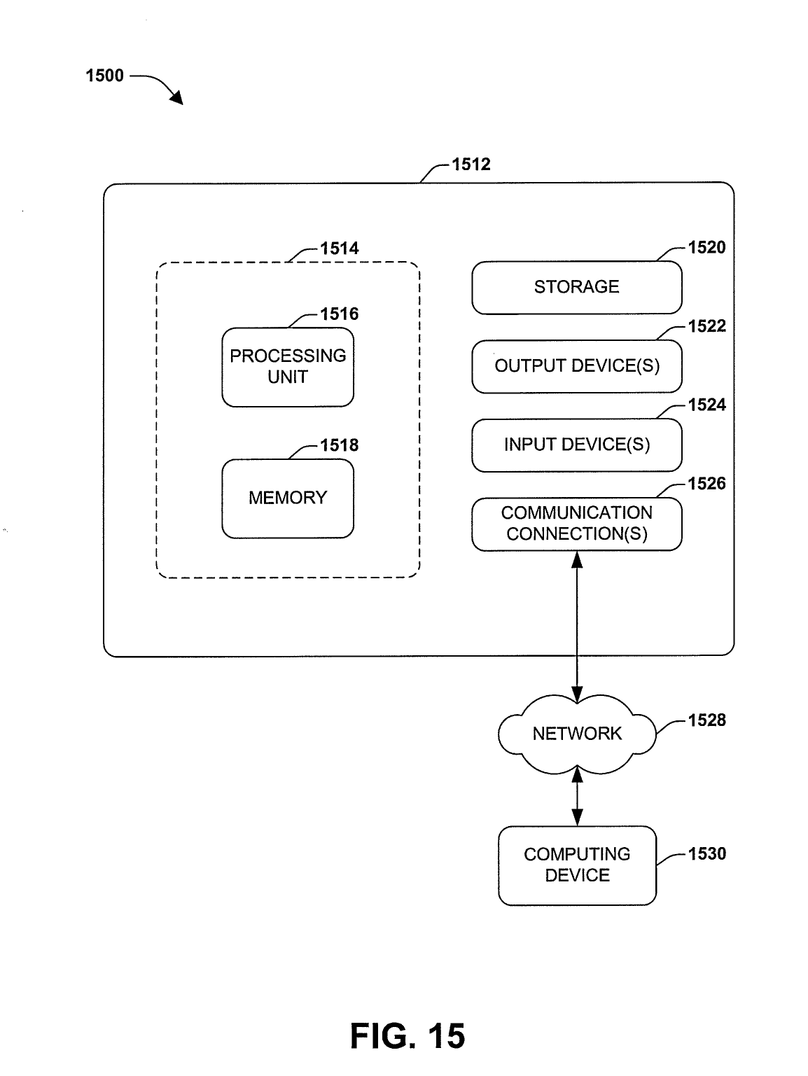

FIG. 15 and the following discussion provide a description of a suitable computing environment in which embodiments of one or more of the provisions set forth herein can be implemented. The operating environment of FIG. 15 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 15 illustrates a system 1500 comprising a computing device 1502 configured to implement one or more embodiments provided herein. In one configuration, computing device 1502 can include at least one processing unit 1506 and memory 1508. Depending on the exact configuration and type of computing device, memory 1508 may be volatile, such as RAM, non-volatile, such as ROM, flash memory, etc., or some combination of the two. This configuration is illustrated in FIG. 15 by dashed line 1504.

In these or other embodiments, device 1502 can include additional features or functionality. For example, device 1502 can also include additional storage such as removable storage or non-removable storage, including, but not limited to, magnetic storage, optical storage, and the like. Such additional storage is illustrated in FIG. 15 by storage 1510. In some embodiments, computer readable instructions to implement one or more embodiments provided herein are in storage 1510. Storage 1510 can also store other computer readable instructions to implement an operating system, an application program, and the like. Computer readable instructions can be loaded in memory 1508 for execution by processing unit 1506, for example.

The term “computer readable media” as used herein includes computer storage media. Computer storage media includes volatile and nonvolatile, removable and non-removable media implemented in any method or technology for storage of information such as computer readable instructions or other data. Memory 1508 and storage 1510 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1502. Any such computer storage media can be part of device 1502.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1502 can include one or more input devices 1514 such as keyboard, mouse, pen, voice input device, touch input device, infrared cameras, video input devices, or any other input device. One or more output devices 1512 such as one or more displays, speakers, printers, or any other output device can also be included in device 1502. The one or more input devices 1514 and/or one or more output devices 1512 can be connected to device 1502 via a wired connection, wireless connection, or any combination thereof. In some embodiments, one or more input devices or output devices from another computing device can be used as input device(s) 1514 or output device(s) 1512 for computing device 1502. Device 1502 can also include one or more communication connections 1516 that can facilitate communications with one or more other devices 1520 by means of a communications network 1518, which can be wired, wireless, or any combination thereof, and can include ad hoc networks, intranets, the Internet, or substantially any other communications network that can allow device 1502 to communicate with at least one other computing device 1520.

What has been described above includes examples of the subject innovation. It is, of course, not possible to describe every conceivable combination of components or methodologies for purposes of describing the subject innovation, but one of ordinary skill in the art may recognize that many further combinations and permutations of the subject innovation are possible. Accordingly, the subject innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates automatic population of a database, comprising:
a carrier component storing information in a carrier format to be submitted to a user;
a retrieval component for accessing and retrieving information on the carrier component; and
a database component for storing the retrieved information in a database compatible format.

2. The system of claim 1, further comprising:
a translating component that converts the retrieved information from the carrier format into the database compatible format.

3. The system of claim 1, further comprising:
a population component that parses the converted information into a plurality of data points.

4. The system of claim 3, wherein the population component inserts the data points into a plurality of associated fields in a database entry on the database component.

5. The system of claim 1, wherein the retrieval component retrieves the information from the carrier component via an automated mailbox retrieval application.

6. The system of claim 5, wherein the automated mailbox retrieval application is a commercial lines download service system.

7. The system of claim 1, wherein the retrieval component retrieves the information from the carrier component based on receipt of a manual selection.

8. The system of claim 1, wherein the information on the carrier component is arranged according to an ACORD standard.

9. The system of claim 1, wherein the database compatible format is a customer relationship management solution format.

10. The system of claim 1, wherein the information stored by the carrier component is information related to an insurance carrier.

11. The system of claim 1, wherein the database component is associated with an insurance entity.

12. A method for facilitating mapping of a form, comprising:
determining a first object field from the database object;
determining a first form field from the selected form; and
mapping the first object field to the first form field.

13. The method of claim 12, further comprising:
associating the first form field and the first object field with each other in a mapping list.

14. The method of claim 12, further comprising:
determining a first database object listing a plurality of available forms; and
determining an available form to map.

15. The method of claim 12, further comprising:
determining additional fields to be mapped;
determining a second object field from the database object;
determining a second form field from the selected form;
mapping the second object field to the second form field; and
updating a mapping list depicting an association of the second object field and the second object field.

16. The method of claim 14, further comprising:
determining a second form from the listing of available forms of the first database object.

17. The method of claim 12, wherein the first form field is associated with an ACORD form.

18. The method of claim 12, wherein the first field object is associated with a customer relationship management solution object.

19. A method for facilitating generation of a form, comprising:
determining a record for an object that has been previously mapped;
determining a form to generate based at least in part on the previously mapped object; and
generating a form in a format based on a user designation.

20. The method according to claim 19, wherein the format of the form is an ACORD eform in one of a PDF, a XML, or other format.
